(19) United States
(12) Patent Application Publication
(10) Pub. No.: US 2008/0150712 A1
(43) Pub. Date: Jun. 26, 2008

(54) TIRE PRESSURE MONITORING (TPM) AND REMOTE KEYLESS ENTRY (RKE) SYSTEM

(75) Inventors: Anthony Cooprider, Rochester Hills, MI (US); Thomas Miller, Ann Arbor, MI (US); Karl Wojcik, Sterling Heights, MI (US); John Van Wiemeersch, Novi, MI (US); Randall Chinoski, Warren, MI (US)

Correspondence Address: BROOKS KUSHMAN P.C./FGTL, 1000 TOWN CENTER, 22ND FLOOR, SOUTHFIELD, MI, 48075-1238, US

(73) Assignee: FORD GLOBAL TECHNOLOGIES, LLC, Dearborn, MI (US)

(21) Appl. No.: 11/614,158

(22) Filed: Dec. 21, 2006

(51) Int. Cl. B60C 23/00

(52) U.S. Cl. 340/447

(57) ABSTRACT

The embodiments described herein include a tire pressure monitoring (TPM)/remote keyless entry (RKE) device and method. The device includes a first antenna and a second antenna. An antenna switch is also included for selecting the first antenna and the second antenna. The controller generates signals for the antenna switch to cause selection of the first antenna and the second antenna for the reception of radio-frequency (RF) signals. Additionally, housing encloses the second antenna, the antenna switch and the controller. Also, at least a portion of the first antenna extends external to the housing.

### TECHNICAL FIELD

The embodiments described herein relate generally to a TPM/RKE system, more particularly to a TPM/RKE device that is operable with the TPM/RKE system.

### BACKGROUND

Tire pressure monitoring (TPM) systems are commonly installed in vehicles to provide a vehicle operator information pertaining to the condition of vehicle tires. Remote keyless entry (RKE) systems are also installed on vehicles for providing a vehicle operator remote access to the vehicle through the use of an electronic device such as a key fob. In most cases, the RKE system and the TPM system have dedicated receivers to enable optimal performance by the TPM system and the RKE system. In a vehicle environment, it is commonly known that packaging space is considerably limited. Accordingly, dedicated modules for the TPM system and RKE system complicates vehicle design and poses undesirable packaging considerations. Thus, there exists the need for a TPM/RKE system having a unitary device configured to optimally receive, process and generate signals for both the TPM system and RKE system.

### SUMMARY

The embodiments described herein include a tire pressure monitoring (TPM)/remote keyless entry (RKE) device and method. The device includes a first antenna and a second antenna. An antenna switch is also included for selecting the first antenna and the second antenna. The controller generates signals for the antenna switch to cause selection of the first antenna and the second antenna for the reception of radio-frequency (RF) signals. Additionally, a device housing encloses the second antenna, the antenna switch and the controller while at least a portion of the first antenna extends external to the housing.

### BRIEF DESCRIPTION OF THE DRAWINGS

The novel features of the described embodiments are set forth with particularity in the appended claims. These embodiments, both as to their organization and manner of operation, together with further advantages thereof, may be best understood with reference to the following description, taken in connection with the accompanying drawings in which:

FIG. 1A illustrates a vehicle having a tire pressure monitoring (TPM)/remote keyless entry (RKE) device in accordance with an embodiment of the present invention;

FIG. 1B illustrates an enlarged view of the TPM/RKE device of FIG. 1A; and

FIG. 2 illustrates a detailed block diagram of the TPM/RKE device of FIG. 1.

### DETAILED DESCRIPTION OF THE EMBODIMENT(S)

As required, detailed descriptions of non-limiting embodiments are disclosed herein. However, it is to be understood that the disclosed embodiments are merely exemplary of the invention that may be embodied in various and alternative forms. The figures are not necessarily to scale, and some features may be exaggerated or minimized to show details of particular components. Therefore, specific functional details disclosed herein are not to be interpreted as limiting, but merely as a representative basis for the claims and/or as a representative basis for teaching one skilled in the art.

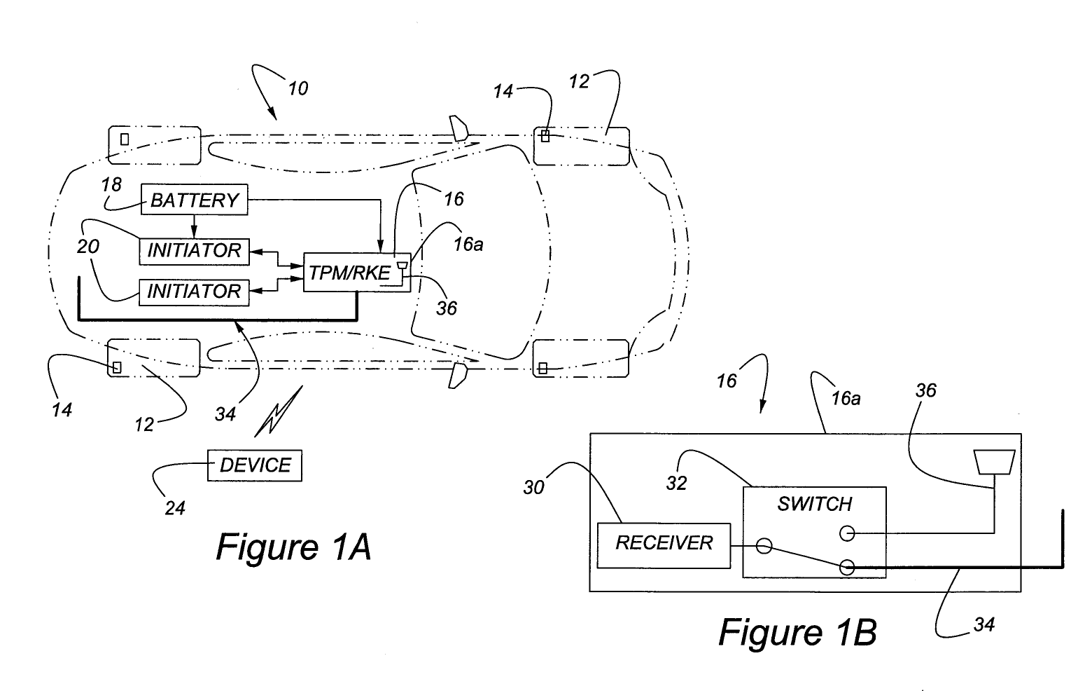

Referring to FIGS. 1A and 1B, a vehicle 10 is illustrated having a tire pressure monitoring (TPM)/remote keyless entry (RKE) device 16. TPM/RKE device 16 includes a housing 16a that encloses an antenna 36, receiver 30, and antenna switch 32. An antenna 34 is coupled to TPM/RKE device 16, but extends external to housing 16a. A plurality of wheels having tires 12 are mounted onto vehicle 10 in a known manner. A TPM sensor 14 is mounted within each tire 12. As recognized by one of ordinary skill in the art, TPM sensors 14 are configured to sense a condition of tires 12 and transmit to a receiving device a signal that corresponds to the sensed tire condition. Vehicle occupants are then notified of the tire condition. In the embodiment described herein, the receiving device includes TPM/RKE device 16.

TPM/RKE device 16, which has a controller, may be adapted to receive, process and decode radio-frequency (RF) signals including TPM signals and RKE signals. In one aspect of the invention, TPM/RKE device 16 is adapted to determine the specific location of each TPM sensor 14 with respect to each tire 12. It is recognized that when TPM sensors 14 are installed within tires 12 that the TPM/RKE device may not know which TPM sensor is located in the respective tire 12. Accurate tire condition notification for vehicle occupants is enabled by TPM/RKE device 16 learning the specific location of a TPM sensor with respect to a specific tire.

Accordingly, in one embodiment, initiators 20, which communicate with TPM/RKE device 16, are configured to generate interrogation signals for TPM sensors 14. The interrogation signals cause TPM sensors 14 to generate TPM signals that enable TPM/RKE device 16 to determine the specific location of the TPM sensors with respect to each tire 12. In one embodiment, TPM/RKE device 16 includes a receiver 30 (FIG. 1B) having the controller. The controller may be programmed to have a received signal strength indicator (RSSI) for determining the strength of the TPM signals. Based on the signal strength and the location of TPM/RKE device 16 on vehicle 10, TPM/RKE device 16 is configured to determine the specific location of TPM sensors 14 with respect to tires 12. It is recognized that although initiators 20 are shown, alternative embodiments may not have initiators 20. In such embodiments, other electronic devices may be utilized for teaching TPM/RKE device 16 the specific location of TPM sensors 14.

TPM/RKE device 16 receives the RF signals (e.g., the TPM signals and RKE signals) through the use of multiple antennas including internal antenna 36 and external antenna 34. In one embodiment, the signal strength of the TPM signals generated in response to the interrogation signals are determined based on the strength of the TPM signals as received by antenna 34.

As shown in FIG. 1A, external antenna 34 extends throughout vehicle 10. Packaging concerns traditionally associated with vehicle placement of conventional TPM modules and RKE modules are minimized by the unitary construction of TPM/RKE device 16 and the routing of antenna 34 throughout the vehicle. It is also recognized that the ability to optimally receive both TPM signals and RKE signals is affected by the location of the receivers on the vehicle. Routing of antenna 34 external to TPM/RKE device 16 and throughout vehicle 10 enhances the reception of both TPM and RKE signals.

FIG. 1B illustrates antennas 34 and 36 being coupled to receiver 30 via an antenna switch 32. In one embodiment, receiver 30 includes the controller that processes the signals received by TPM/RKE device 16. Receiver 30 is also configured to generate control signals for antenna switch 32 to switch between antennas 34 and 36. When it is desirable for receiver 30 to process signals received by antenna 34 or 36, the controller generates the control signals for switch 32 to select either antenna 34 or 36.

For example, to determine the signal strength of TPM signals while TPM/RKE device 16 is learning the specific locations of TPM sensors 14, antenna switch 32 would be positioned so as to couple antenna 34 to receiver 30. Additionally, in some embodiments internal antenna 36 is configured to receive TPM signals that indicate the condition of tires 12. As such, when TPM signals are being generated for notifying vehicle occupants of the tire condition, antenna switch 32 would be positioned so as to couple antenna 36 to receiver 30. The TPM signals indicative of tire condition could be received and processed by receiver 30.

As described above, TPM/RKE device 16 is configured to receive, process and generate RKE signals. In one embodiment, antenna 36 is configured to receive RKE signals from a wireless device such as device 24. Device 24, which may be a wireless key fob that enables a vehicle operator to lock and unlock doors (not shown) on vehicle 10. Additionally, device 24 may be used as a remote starting device and the like.

Antenna 36 may be selected when receiving RKE signals when device 24 is within a first distance range from TPM/RKE device 16. For example, when device 24 is within 15 meters of TPM/RKE device 16, antenna 36 is configured to receive the RKE signals. Alternatively, in the event that device 24 is in a range greater than the range for antenna 36, antenna 34 is configured to receive the RKE signals. For example, when device 24 is within a distance range greater than 15 meters from TPM/RKE device 16, antenna 34 is configured to receive the RKE signals to cause locking or unlocking of doors on vehicle 10. Accordingly, antenna switch 32 would receive control signals for coupling antenna 34 to receiver 30. The described distance ranges are merely exemplary and may vary without departing from the scope of the present invention.

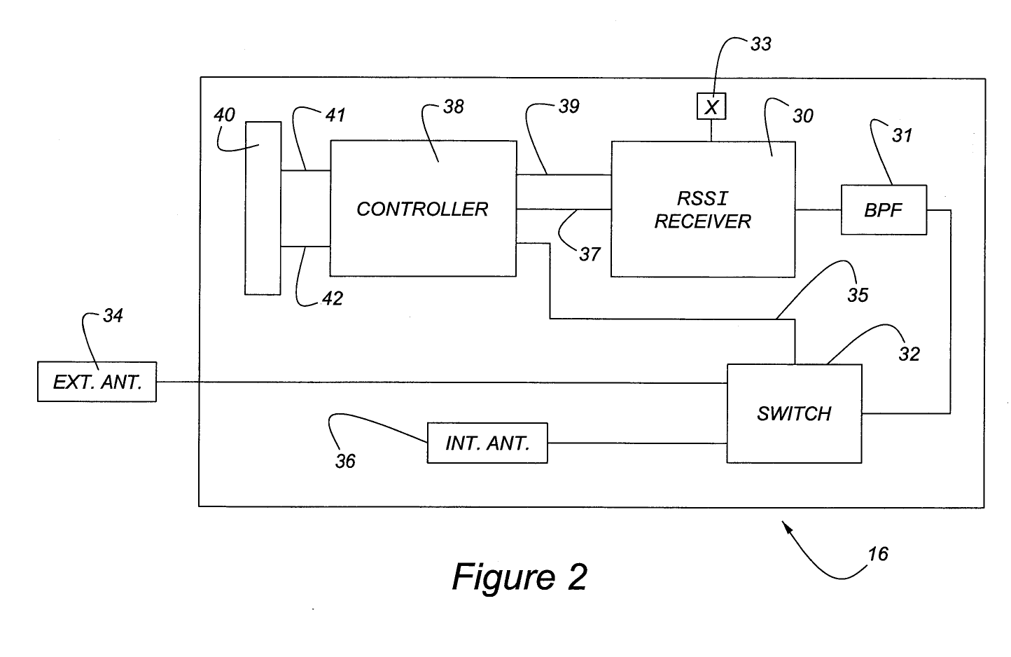

Now, referring to FIG. 2, a detailed block diagram of TPM/RKE device 16 is provided. As described in the foregoing, a receiver 30 is included. In this embodiment, the controller 38 is shown as a discrete device as opposed to be integrated with receiver 30. However, it is recognized that controller 38 may be integrated with receiver 30 without departing from the scope of the present invention. As shown, receiver 30 includes the RSSI so as to enable controller 38 to determine the specific location of TPM sensors on the vehicle based on the signal strength of received TPM signals.

As described in the forgoing, RF signals (e.g., TPM and/or RKE signals) may be received by antenna 34 and 36. Antenna switch 32 receives a control signal via control line 35 that causes signals received by either antenna 34 or 36 to be transmitted to receiver 30 and ultimately to controller 38. Signals received by either antenna 34 or 36 propagate through antenna switch 32 to a band pass filter 31. Filter 31 filters signals routed through switch 32 thereby causing the signals to have a frequency that is acceptable for processing by receiver 30. It is recognized that in some embodiments, matching network devices may be included throughout the circuit to reduce signal degradation as the signal propagates through the circuit.

The signals received by receiver 30 are mixed with reference signals from an oscillator 33, which may be a crystal oscillator. In some cases the signals as received by receiver 30 may have a frequency that higher than desirable. Accordingly, mixing the signals from antenna 34 or 36 with the reference signal produces a lower frequency signal that may be processed by controller 38.

The RSSI, which is shown being integrated with receiver 30, provides signal strength signals to controller 38 over analog voltage line 39. The signals transmitted over analog voltage line 39 allow controller 38 to determine the location of each TPM sensor on the vehicle based on the signal strength of the TPM signals. Data line 37 may serve as a conduit for transmitting TPM sensor signals indicative of tire condition and RKE signals from a key fob.

Controller 38 processes the received signals and communicates tire condition and/or causes locking/unlocking of the vehicle doors via communications lines 41 and 42. As commonly known, controller 38 may provide a notification of tire condition and other information to a vehicle network via a network connection 40.

While the best mode for carrying out the invention has been described in detail, those familiar with the art to which this invention relates will recognize various alternative designs and embodiments for practicing the invention as defined by the following claims. For example, it is recognized that the specific types of signals (i.e., TPM and RKE signals) received by the internal and external antenna may vary based upon the location of the TPM/RKE module within the vehicle. For example, in alternative embodiments, external antenna 34 may be configured to receive TPM signals that indicate the condition of tires 12 as opposed to internal antenna 36. Additionally, when TPM signals are being generated for notifying vehicle occupants of the tire condition, external antenna 34 may be used. Furthermore, in some embodiments, internal antenna 36 may be configured to receive RKE signals from a remote key fob.

What is claimed:

1. A tire pressure monitoring (TPM)/remote keyless entry(RKE) device comprising:
a first antenna;
a second antenna;
an antenna switch for selecting the first antenna and the second antenna;
a controller generating signals for the antenna switch to cause selection of the first antenna and the second antenna for the reception of radio-frequency (RF) signals; and
a housing, wherein the second antenna, the antenna switch, and the controller are enclosed within the housing, and wherein at least a portion of the first antenna extends external to the housing.

2. The device of claim 1, further comprising an oscillator being coupled to the controller for providing a reference signal that is mixed with signals received by the first antenna and the second antenna.

3. The device of claim 1, further comprising a received signal strength indicator (RSSI) for determining the strength of the signals received by the first antenna.

4. The device of claim 1, wherein the second antenna is configured to receive RF signals that include TPM signals that indicate a condition of tires on a vehicle.

5. The device of claim 4, wherein the second antenna is configured to receive RF signals including RKE signals from a wireless device when the wireless device is within a first distance range from the TPM/RKE device.

6. The device of claim 5, wherein the first antenna is configured to:
receive RKE signals from the wireless device when the wireless device is within a second distance range, wherein the second distance range is greater than the first distance range from the TPM/RKE device; and
receive RF signals including TPM signals for determining a location of multiple TPM sensors.

7. The device of claim 1 further comprising a plurality of initiators being operable with the controller for interrogating a plurality of TPM sensors to determine a location of each TPM sensor.

8. A method for receiving tire pressure monitoring (TPM) signals and remote keyless entry(RKE) signals, the method comprising:
configuring a TPM/RKE device to have a housing, a first antenna, a second antenna, an antenna switch and a controller, wherein the second antenna, the antenna switch and the controller are enclosed within the housing while a portion of the first antenna extends outside of the housing;
configuring the antenna switch to select the first antenna and the second antenna in response to a control signal; and
generating signals for the antenna switch to select the first antenna and the second antenna for the reception of the TPM signals and the RKE signals through the use of the controller.

9. The method of claim 8, further comprising an oscillator being coupled to the controller for providing a reference signal that is mixed with signals received by the first antenna and the second antenna.

10. The method of claim 8, further comprising a received signal strength indicator (RSSI) for determining the strength of the signals received by the first antenna.

11. The method of claim 8, wherein the second antenna is configured for receiving TPM signals the indicate a condition of tires on a vehicle.

12. The method of claim 11, wherein, the second antenna is configured for receiving RKE signals from a wireless device when the wireless device is within a first distance range from the TPM/RKE device.

13. The method of claim 12, wherein the first antenna is configured for receiving RKE signals from the wireless device when the wireless device is within a second distance range, wherein the second distance range is greater than the first distance range from the TPM/RKE device.

14. The method of claim 13, wherein the first antenna is configured to receive TPM signals for determining a location of multiple TPM sensors.

15. The method of claim 8, further comprising a plurality of initiators being operable with the controller for interrogating a plurality of TPM sensors to determine a location of each TPM sensor.

16. A tire pressure monitoring (TPM)/remote keyless entry(RKE) device for a vehicle having multiple tires, wherein each tire has a TPM sensor, the device comprising:
a first antenna configured to receive TPM signals for determining a location of each TPM sensor on the vehicle;
a second antenna configured to:
receive TPM signals the indicate a condition the tires, and
receive RKE signals from a wireless device when the wireless device is within a first distance range from the TPM/RKE device;
an antenna switch for selecting the first antenna and the second antenna, wherein upon selecting the first antenna and the second antenna, the first antenna and the second antenna are configured to receive the TPM signals and the RKE signals;
a controller generating signals for the antenna switch to cause selection of the first antenna and the second antenna for the reception of the signals, the controller having a received signal strength indicator (RSSI) for determining the strength of the signals received by the first antenna; and
a housing, wherein the second antenna, the antenna switch, and the controller are enclosed within the housing, and wherein the first antenna is mounted external to the housing.

17. The device of claim 16, wherein the first antenna is configured to receive the RKE signals from the wireless device when the wireless device is within a second distance range, wherein the second distance range is greater than the first distance range from the TPM/RKE device.

18. The device of claim 16, further comprising a plurality of initiators being operable with the controller for interrogating the TPM sensors for determining a location of each TPM sensor.
